(19) United States
(12) Patent Application Publication
(10) Pub. No.: US 2012/0218139 A1
(43) Pub. Date: Aug. 30, 2012

(54) CORRELATION FILTER FOR TARGET SUPPRESSION, WEIGHT CALCULATION METHOD, WEIGHT CALCULATION DEVICE, ADAPTIVE ARRAY ANTENNA, AND RADAR DEVICE

(75) Inventors: Junichiro SUZUKI, Kanagawa-ken (JP); Mitsuyoshi Shinonaga, Kanagawa-ken (JP); Yoshikazu Shoji, Kanagawa-ken (JP)

(73) Assignee: Kabushiki Kaisha Toshiba, Tokyo (JP)

(21) Appl. No.: 13/361,382

(22) Filed: Jan. 30, 2012

(30) Foreign Application Priority Data
Feb. 28, 2011 (JP) 2011-043035

(51) Int. Cl. G01S 7/292

(52) U.S. Cl. 342/189

(57) ABSTRACT

In an adaptive array antenna, an array antenna receives a signal containing a reflected target signal of a radar pulse, a correlation filter circuit suppresses a component correlating with a target signal in the received signal by applying a correlation filter to the received signal, a weight calculation circuit calculates an adaptive weight from data processed with application of the correlation filter, and a beam synthesizing circuit creates output data by performing weight control on the received signal by using the adaptive weight.

### CROSS-REFERENCE TO RELATED APPLICATION(S)

This application is based upon and claims the benefit of priority from the prior Japanese Patent Application No. 2011-43035, filed on Feb. 28, 2011, the entire contents of which are incorporated herein by reference.

### FIELD

Embodiments relate to a correlation filter configured to suppress a component correlating with a target signal in a received signal, a weight calculation method of calculating a weight suitable for weight control of extracting a signal reflected from a target from a received signal by suppressing an undesired wave component, a weight calculation device using the weight calculation method, an adaptive array antenna using the weight calculation device, and a radar device including the adaptive array antenna.

### BACKGROUND

In recent years, for improving a target detection accuracy, a pulse radar device has incorporated an adaptive array antenna and has performed a so-called adaptive null steering. The adaptive null steering is processing in which the adaptive array antenna forms a received synthetic beam so that a gain in a direction from which an undesired wave, such as an interfering wave, arrives can be zero (null) by performing weight control on the phases and amplitudes of received signals of antenna elements. The adaptive array antenna is required to perform the weight control so that a received synthetic beam can be properly formed even under environments in which a large number of delayed signals arrive and in which clutter and an undesired wave, such as an interfering wave, are present.

For this reason, with regard to the adaptive array antenna, an attention has been paid to weight control methods employing a side lobe canceller (SLC) and a space-time adaptive processing (STAP). The side lobe canceller (SLC) and the space time adaptive processing (STAP) improve a signal to interference pulse noise ratio (SINR) and have characteristics of having the ability to form an optimum beam in which a gain in the arrival direction of the undesired wave is close to zero (null).

In the space time adaptive processing (STAP), the following processing is performed. The adaptive array antenna has a processing range cell for each antenna element. Each processing range cell includes range cells each having a width corresponding to a received pulse width and arranged continuously with predetermined lengths on a time axis. A signal reflected from a target or the like is received by multiple antenna elements arranged in an array. The received signal of each antenna element is stored in the processing range cell for the antenna element, that is, in a range cell corresponding to a position where the radar pulse is reflected. Then, a covariance matrix is operated from the data stored in range cells supposed to include only undesired waves. In other words, a covariance matrix is operated from the data stored in range cells other than range cells supposed to include a target signal being the reflected signal from the target. Then, a beam synthesizing circuit performs weight control on the signal received by each antenna element by using an adaptive weight calculated for each weight application range.

Prior Art Document: Space-Time Adaptive Processing for Radar, J. R. Guerci, Artech House, Norwood, Mass., 2003. This prior art document describes the space-time adaptive processing.

However, in the undesired signal suppression method using the weight control of the adaptive array antenna, which is used in conventional radar device, if a target signal is present in received signals used in weight calculation for nullifying a gain in the arrival direction of an undesired wave, the target signal is also suppressed together with the undesired signal. To avoid this problem, in the conventional undesired signal suppression method, a received signal is divided into multiple ranges and a weight is calculated from data from which the data of a weight application range are removed. For this reason, in the conventional undesired signal suppression method, a weight has to be calculated for each weight application range, and therefore the method requires a longer operation time.

### BRIEF DESCRIPTION OF THE DRAWINGS

FIG. 1 is a graph showing a characteristic of a received signal to which a correlation filter according to an embodiment is applied.

FIG. 2 is a view showing a concept of a received signal and conventional weight processing.

FIG. 3 is a block diagram showing a functional configuration of a receiver unit of a radar device using the correlation filter according to the embodiment.

FIG. 4 is a view showing a concept of a received signal and weight processing according to the embodiment.

FIG. 5 shows output data of a beam synthesizing unit, some of which are output data when the correlation filter according to the embodiment is applied and the others of which are outputted data when the correlation filter is not applied.

FIG. 6 is a block diagram showing a configuration of a weight calculation device according to the embodiment.

FIG. 7 is a block diagram showing a schematic configuration of a radar device according to an embodiment.

FIG. 8 is a view showing a flow of the processing according to the embodiment.

A correlation filter according to an embodiment is used in a radar device including an adaptive array antenna configured to form a received synthetic beam from a received signal outputted by an antenna array having a plurality of antenna elements arranged in an array, in such a way that an adaptive weight for a phase and amplitude of the received signal is applied to the received signal to nullify a gain in a direction other than an arrival direction of a target signal which is a reflected signal of a radar pulse reflected from a target and is contained in the received signal. The correlation filter includes coefficient calculating means and coefficient applying means. With use of a reference signal being a sample value of a transmission waveform of a radar pulse transmitted by the radar device, the coefficient calculating means calculates in advance a filter coefficient for suppressing a component correlating with the target signal in the received signal. The coefficient applying means removes the component correlating with the target signal from the received signal by applying the filter coefficient calculated by the coefficient calculating means. The correlation filter is used as preprocessing before calculation of the adaptive weight.

Embodiments will be described below with reference to the drawings. A correlation filter according to an embodiment removes, from a received signal, a component correlating with a target signal which is a reflected signal reflected from a target. There are the following correlation filters as the correlation oppression filter.
(1) A correlation filter in which a filter coefficient is calculated in advance by using a reference signal and then the calculated filter coefficient is applied to a received signal.
(2) A correlation filter in which multiple filter coefficients are calculated in advance by using multiple reference signals and then these filter coefficients are applied to a received signal.
(3) A correlation filter in which a filter coefficient is dynamically calculated by using a reference signal estimated from a received signal and then the calculated filter coefficient is applied to the received signal.
(4) A correlation filter in which any of the correlation filters (1) to (3) is included in multiple stages.

These correlation filters create a signal in which a component correlating with a target signal is removed from a received signal of each antenna element. Also, the weight calculation unit calculates a weight to suppress an undesired signal in the received signal based on the created signal. This provides a faster weight calculation time. Note that a same derivation method is used in all of the above-described correlation filters (1) to (4).

Here, the following equation (1) gives an input signal column vector A⁻ (where⁻ shows a vector) which is inputted to a pulse compression filter to compress a received signal.

A=[a₁ a2, . . . , a_{N}] (1)

This is an input signal column vector corresponding to a code assigned by a radar transmission source. In other words, this vector element is I/Q sampling datum in a temporal sequence in a range direction within a transmission pulse and is equivalent to a sample value (a reference signal) of a radar transmission waveform.

Next, the following equation (2) gives an input signal state matrix X to a pulse compression filter.

$$X = [ \begin{matrix}{a}_{1} & & 0 & \\ {a}_{2} & {a}_{1} & & \\ ⋮ & & ⋱ & \\ {a}_{N} & {a}_{N - 1} & … & {a}_{1} \\ & {a}_{N} & & \\ & & ⋱ & ⋮ \\ & 0 & & {a}_{N}\end{matrix} ] \qquad ( 2 )$$

Furthermore, a filter coefficient vector in the pulse compression filter can be expressed as an n-tap FIR filter coefficient H⁻ by the following equation (3).

$$\begin{matrix}H = [ \begin{matrix}{h}_{1} & {h}_{2} , & … , & {h}_{N}\end{matrix} ] \\ = [ \begin{matrix}{w}_{1} {F}_{1} & {w}_{2} {F}_{2} , & … , & {w}_{N} {F}_{N}\end{matrix} ] \\ = FW\end{matrix} \qquad ( 3 )$$

where F⁻ is an N-th degree coefficient vector of an optimum filter (matched filter) and W is equivalent to a window function and is a diagonal matrix of N dimensions.

Using these, an output temporal sequence y of the pulse compression filter can be expressed by the following equation (4).

y=HX^{T} (4)

where ^{T} shows a transposed matrix.

When the equation (4) is caused to correspond to an FFT frequency spectrum, the equation (4) can be expressed by the following equation (5).

y=HX^{T} [symbol] Qy_{z}^{T}=Q(H_{z}X_{z}^{T})^{T}=QX_{z}H_{z}^{T} (5)

Here, an FFT operation matrix Q and an IFFT operation matrix \hat{Q} are respectively defined by the following equations (6) and (7) as an operation matrix.

$$\begin{matrix}Q = [ \begin{matrix}{q}_{11} & … & {q}_{1 {N}_{f}} \\ ⋮ & & ⋮ \\ {q}_{{N}_{f} 1} & … & {q}_{{N}_{l} {N}_{f}}\end{matrix} ] & ( 6 ) \\ \hat{Q} = \frac{{Q}^{H}}{{N}_{f}} \\ here , {q}_{nk} = {e}^{- j \frac{2 π}{{N}_{f}} ( n - 1 ( k - 1 ) )} \\ n , k = 1 \sim {N}_{f} & ( 8 )\end{matrix}$$

Note that N_{f} is the number of FFT points, and ^{H} is a complex conjugation.

Also, it is assumed that the number N_{f} of FFT points is larger than the number (2N−1) of output temporal sequence points of the pulse compression filter.

Furthermore, 0 is added according to the number N_{f} of FFT points as shown in the following equations (8), (9), (10), (11), and (12).

$$\begin{matrix}{y}_{z} = \begin{matrix}[ y & \overbrace{\begin{matrix}0 & … & 0\end{matrix}}^{{N}_{f} - ( 2 N - 1 )} ]\end{matrix} & ( 8 ) \\ {H}_{z} = \begin{matrix}[ H & \overbrace{\begin{matrix}0 & … & 0\end{matrix}}^{{N}_{f} - N} ]\end{matrix} & ( 9 ) \\ {X}_{z} = {\overbrace{[ \begin{matrix}X & 0 \\ 0 & 0\end{matrix} ]}^{{N}_{f} - N}}_{\} {N}_{f} - ( 2 N - 1 )} & ( 10 ) \\ {F}_{z} = \begin{matrix}[ y & \overbrace{\begin{matrix}0 & … & 0\end{matrix}}^{{N}_{f} - N} ]\end{matrix} & ( 11 ) \\ {A}_{z} = \begin{matrix}[ A & \overbrace{\begin{matrix}0 & … & 0\end{matrix}}^{{N}_{f} - N} ]\end{matrix} & ( 12 )\end{matrix}$$

Furthermore, the following equation (13) gives an output vector from which a main lobe neighborhood ±Nₓ point is removed (is set as 0), that is, a target signal (expected value) yₘ.

yₘ=[y₁ . . . y_{N-N}_{_{z}}₋₁ 0 . . . 0 y_{N+N}_{_{z}}₊₁ . . . y_{2N-1}9 (13)

Here, as shown by the equation (4), an output temporal sequence y_{mz} of the pulse compression filter of the target signal can be expressed by the following equation (14).

$${y}_{mz} = \begin{matrix}[ {y}_{m} & \overbrace{\begin{matrix}0 & … & 0\end{matrix}}^{{N}_{f} - ( 2 N - 1 )} ] = {H}_{dx} {X}_{z}^{T}\end{matrix} \qquad ( 14 )$$

As is clear from the equations (13) and (14), H_{dz} is a coefficient vector to suppress the target signal and can be calculated using the following equations (15) to (21).

$$\begin{matrix}{H}_{dz}^{T} = \hat{Q} {GQy}_{mz}^{T} = \hat{Q} {GQX}_{mz} {H}_{z}^{T} & ( 15 ) \\ {X}_{m} = [ \begin{matrix} & & 0 & & & & 0 \\ {a}_{N - {N}_{z}} & & … & … & {a}_{1} & & \\ ⋮ & & & & & ⋱ & \\ {a}_{N} & & {a}_{N - 1} & … & … & … & {a}_{1} \\ & ⋱ & & & & & \\ & & {a}_{N} & … & … & … & {a}_{{N}_{z} + 1} \\ 0 & & & 0 & & & \end{matrix} ] & ( 16 ) \\ {X}_{m} = {\overbrace{[ \begin{matrix}{X}_{m} & 0 \\ 0 & 0\end{matrix} ]}^{{N}_{f} - N}}_{\} {N}_{f} - ( 2 N - 1 )} & ( 17 ) \\ {H}_{z} = {α}^{*} {F}_{Z} {u}^{*} {z}^{- 1} α : constant & ( 18 ) \\ u = \hat{Q} {GQX}_{mz} = \frac{1}{{N}_{f}} {Q}^{*} {GQX}_{mz} & ( 19 ) \\ z = {X}_{mz}^{T} ( {Q}^{T} {G}^{T} {G}^{*} {Q}^{*} ) {X}_{mz}^{*} & ( 20 ) \\ G = [ \begin{matrix}\frac{1}{{( {QA}_{1}^{T} )}_{1}} & & & 0 \\ & \frac{1}{{( {QA}_{z}^{T} )}_{2}} & & \\ & & ⋱ & \\ 0 & & & \frac{1}{{( {QA}_{z}^{T} )}_{{N}_{l}}}\end{matrix} ] & ( 21 )\end{matrix}$$

Note that the input signal column vector A⁻ in the equation (1) is changed to another input signal series, so that a correlation filter for multiple reference signals can be easily achieved. Also, the target signal is estimated from the received signal and the estimated target signal is used as a reference signal, so that the received signal can be used as an input signal column vector. Additionally, the correlation filter to suppress the component correlating with the target signal can be applied to the received signal multiple times. Furthermore, when the correlation filter is applied multiple times, the reference signal can be also changed. In addition, a set value of the ±Nₓ is expanded to the side lobe region, so that not only the main lobe neighborhood but also the side lobe region can be suppressed.

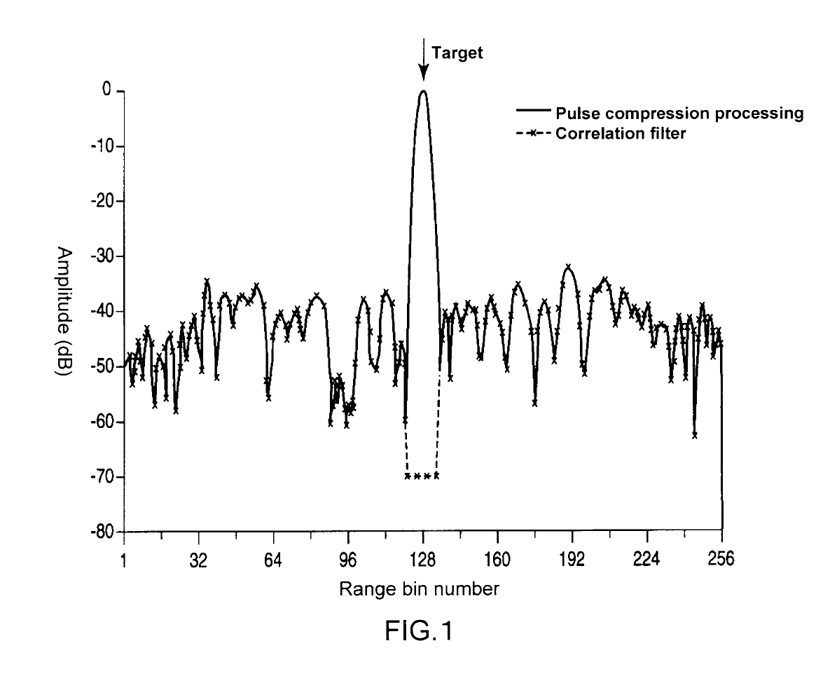

Here, as an example of the embodiment, FIG. 1 shows a signal of a processing result in which the derived correlation filter is applied to the received signal in FFT (fast Fourier transformation) points 512, Nₓ=6, a range bin 128 where the target signal is present. In FIG. 1, a solid line shows a processing result by the pulse compression filter and a dotted line shows a processing result in which the correlation filter is applied. As shown by the dotted line, the component correlating with the target signal is suppressed by applying the correlation filter.

And now, as an example of deriving an undesired signal suppression weight by using the processing result in which the correlation filter is applied to the received signal, a space-time adaptive processing (STAP) is now considered.

When a direction matrix in an arrival direction of a received signal X is A, a complex amplitude vector is S, a mean is 0, and a thermal noise given by distribution σ² is n, the received signal X is expressed by the following equation (22).

X=A·S+n (22)

Also, when the target signal is received by N antenna elements #n (n: 1−N) arrayed at intervals dx and a wavelength of the received frequency signal is λ(Λ), a steering vector a(θd) which determines the arrival direction of D arriving target signals d (d: 1−D) can be expressed by the following equation (23).

$$a ( {θ}_{d} ) = [ \begin{matrix}exp ( j \frac{2 π}{λ} d x \cdot 0 \cdot sin {θ}_{d} ) \\ exp ( j \frac{2 π}{λ} d x \cdot 1 \cdot sin {θ}_{d} ) \\ ⋮ \\ exp ( j \frac{2 π}{λ} d x \cdot ( m - 1 ) \cdot sin {θ}_{d} )\end{matrix} ] \qquad ( 23 )$$

Here, an angular direction, that is, a direction matrix Aθ with respect to a space series is expressed as the following equation (24).

A_{θ}=[a(θ₁), a(θ₂), . . . , a(θ_{D})] (24)

Furthermore, when a Doppler frequency of the target signals d is fd and an interval between M received pulses is T, a steering vector a(fd) in the time direction is expressed by the following equation (25).

$$a ( {f}_{d} ) = [ \begin{matrix}exp ( j2π \cdot \frac{0}{T} \cdot {f}_{d} ) \\ exp ( j2π \cdot \frac{1}{T} \cdot {f}_{d} ) \\ ⋮ \\ exp ( j2π \cdot \frac{( l - 1 )}{T} \cdot {f}_{d} )\end{matrix} ] \qquad ( 25 )$$

For this reason, the temporal sequence direction matrix Af for all the received pulses is expressed by the following equation (26).

A_{f}=[a(f₁), a(f₂), . . . , a(f_{D})] (26)

Thus, the direction matrix A(θ, f) is given by the following equation (28) using the time-space steering vector a(θd, fd) which is expressed by the equation (27).

$$\begin{matrix}a ( {θ}_{d} , {f}_{d} ) = [ \begin{matrix}exp ( j2π \cdot \frac{0}{T} \cdot {f}_{d} ) \cdot a ( {θ}_{d} ) \\ exp ( j2π \cdot \frac{1}{T} \cdot {f}_{d} ) \cdot a ( {θ}_{d} ) \\ ⋮ \\ exp ( j2π \cdot \frac{( l - 1 )}{T} \cdot {f}_{d} ) \cdot a ( {θ}_{d} )\end{matrix} ] & ( 27 ) \\ {A}_{θ , f} = [ a ( {θ}_{1} , {f}_{1} ) , a ( {θ}_{2} , {f}_{2} ) , … , a ( {θ}_{D} , {f}_{D} ) ] & ( 28 )\end{matrix}$$

Here, when an input vector of (NM×1) dimensions at time k is Xₖ, a covariance matrix R calculated from K-sample is given by the following equation (29).

$$R = \frac{1}{K} {\sum }_{n = k}^{K + k - 1} {x}_{n} \cdot {x}_{n}^{H} \qquad ( 29 )$$

For example, a weight w of a Wiener Filter for one target is calculated by the following equation (30) when the steering vector a(θd, fd) in the equation (28) is selected and is set as s.

$$w = \frac{{R}^{- 1} s}{{s}^{H} {R}^{- 1} s} \qquad ( 30 )$$

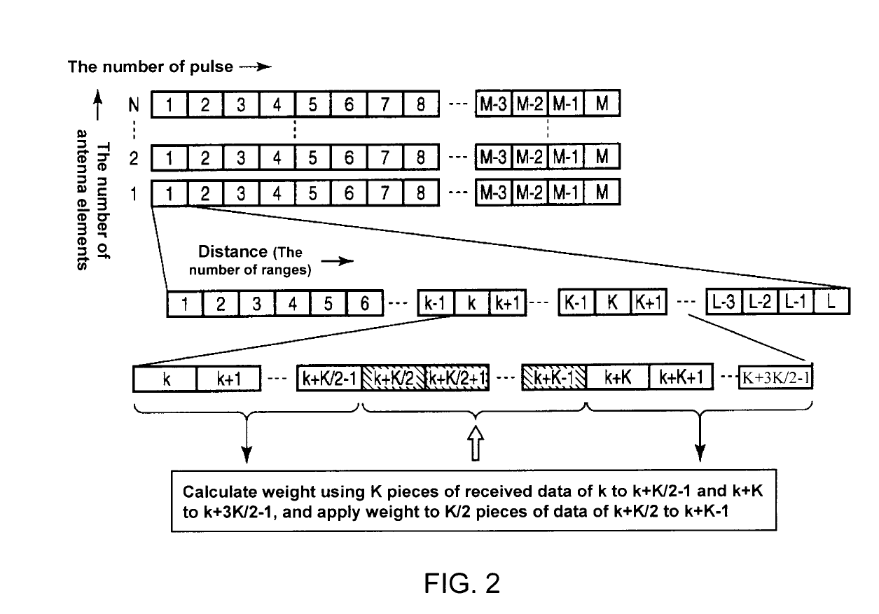

FIG. 2 shows a conceptual diagram in which a weight is applied to a received signal in a case where the number of antennas is N, the number of received pulses is M, and a distance (the number of ranges) is L. FIG. 2 shows how a weight is applied to K-sample from k−k+K/2−1 and k+K−k+3K/2−1. It can be seen from FIG. 2 and the equation (30) that the weight calculation requires an inverse matrix operation in the NM dimensions. Also, FIG. 2 shows the case where a weight is applied to the K/2-sample from k+K/2−k+K−1. It can be seen from FIG. 2 that a weight has to be calculated for all of the received signals and the number of weight calculations increases according to the number of dividing the data to which the weight is applied. For this reason, a time required for calculating the weight increases.

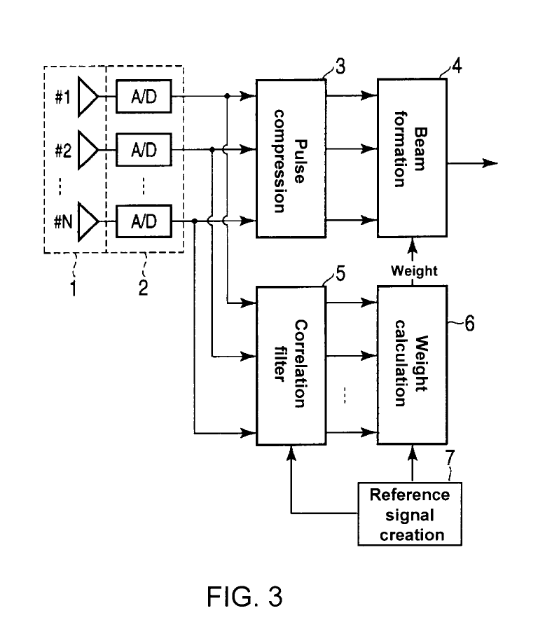

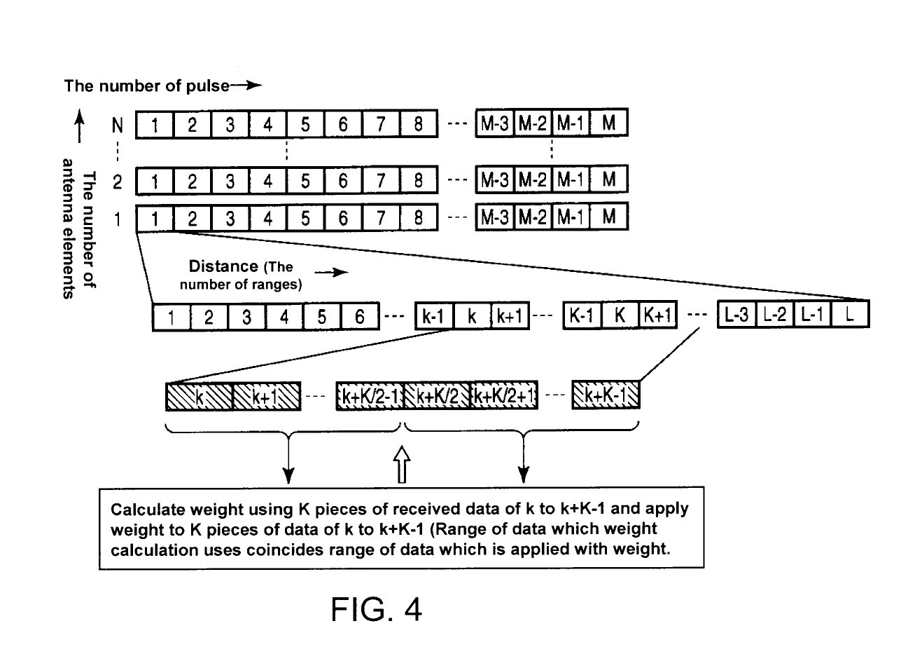

Referring now to FIGS. 3 and 4, the description is given to the concept of a case where STAP is applied to the received signal using a processing result in which a correlation filter is applied to the received signal. FIG. 3 shows a functional configuration of a receiver unit of a radar device using the correlation filter according to the embodiment. FIG. 4 shows a conceptual diagram in which a weight according to the embodiment is applied to the received signal in a case where the number of antenna elements is N, the number of received pulses is M, and a distance (the number of ranges) is L.

In FIG. 3, the signals that the antenna elements #1 to #N of the array antenna 1 receive are respectively converted to digital signals by an A/D converter 2 and the converted digital signals are sent to a pulse compression unit 3 and a correlation filter unit 5. The pulse compression unit 3 includes a memory region corresponding to multiple processing range cells. The number of the processing range cells corresponds to the number of the antenna elements. Each processing range cell has multiple range cells, each range cell being equivalent to a pulse width, and the number of range cells is equivalent to a predetermined distance. The pulse compression unit 3 compresses an output signal of the A/D converter 2. The pulse compression unit 3 sequentially stores the compressed output signal in a range cell corresponding to a receive timing of the received signal within the processing range cell corresponding to the antenna element, and sequentially sends the compressed output signal to a beam synthesizing unit 4.

On the other hand, the correlation filter unit 5 applies correlation filter processing to the digitized received signal and sends the processing result to a weight calculation unit 6. The weight calculation unit 6 calculates a weight to suppress an undesired signal utilizing the processing result of the correlation filter processing. Note that a reference signal which is created by a reference signal creation unit 7 is given to the correlation filter unit 5 and the weight calculation unit 6.

In other words, in the receiver unit of the radar device with the above-described configuration, the correlation filter unit 5 applies the correlation filter processing based on the reference signal to all the received signals. Also, the weight calculation unit 6 calculates an undesired signal suppression weight based on the reference signal using the data of the processing result of the correlation filter processing. That is to say, the weight calculation unit 6 calculates a weight for a phase and amplitude of each received signal stored in the pulse compression unit 3 so that the beam synthesizing unit 5 can suppress the undesired signal. After that, the beam synthesizing unit 4 applies the undesired signal suppression weight to the output signal of the pulse compression unit 3 to form a beam. As a result, as shown in FIG. 4, a weight is calculated from the k received signals up to k−k+K−1, and the weight is applied to the K-sample up to k−k+K−1. The range of the data in which the weight is calculated matches with the range of the data in which the weight is applied.

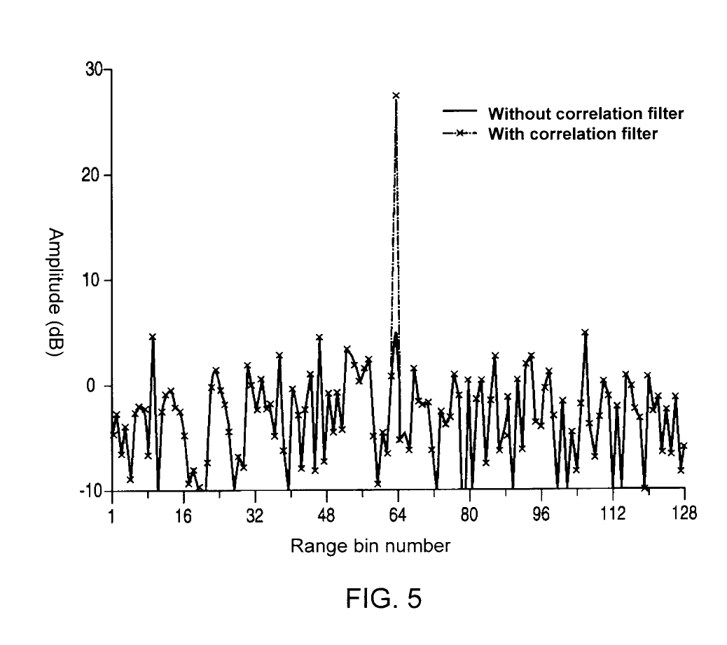

Here, as an example of the embodiment, FIG. 5 shows cases in the bin 64-bin in which a target is present where a correlation filter is applied and where a correlation filter is not applied. FIG. 5 shows output data which are outputted by the beam synthesizing unit 4. In FIG. 5, a solid line shows output data when a weight calculated based on the received signal to which the correlation filter is not applied is used to perform the undesired signal suppression processing, while an alternate long and short dash line shows output data when a weight calculated based on the processing result of the correlation filter which is applied to the received signal is used to perform the undesired signal suppression processing. If the correlation filter is not applied, a target signal component is present in the received signal which is used for the weight calculation. Thus, the target signal is suppressed by the undesired signal suppression processing. However, if the correlation filter is applied, the target signal is not suppressed.

Consequently, in the embodiment, the correlation filter can surely remove the target signal component from the received signal. Thus, with a view to avoiding the suppression of the target signal in the weight processing, there is no need to divide the received signal into multiple ranges and to calculate, from the data from which the data of a weight application range are removed, a weight for each weight application range. For this reason, in the weight calculation method according to the embodiment, a weight can be obtained with at least one calculation on the received signal. This provides a faster operation time and a good SINR characteristic with respect to a target Doppler frequency.

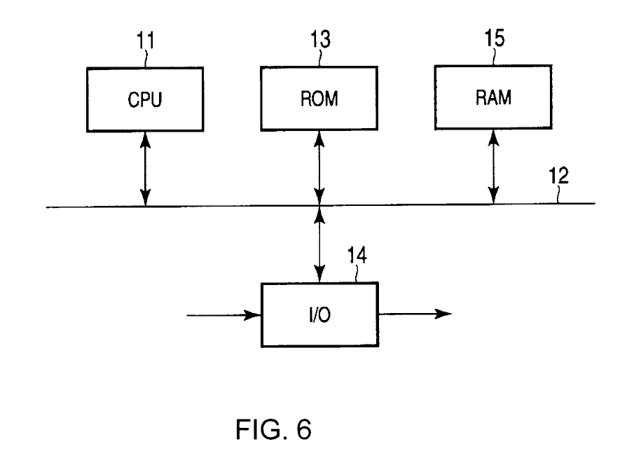

FIG. 6 is a block diagram showing the weight calculation device according to the embodiment. The weight calculation device has a CPU (Central Processing Unit) 11, a ROM (Read Only Memory) 13, a RAM (Random Access Memory) 15, an I/O (Input/Output Interface) 14, and a bus 12. The CPU 11 is connected to the ROM 13, the I/O 14, and the RAM 15 via the bus 12. The ROM 13 stores weight calculation programs relating to the embodiment. When an instruction to start processing is made, the CPU 11 loads a program from the ROM 13. Also, the CPU 11 fetches data via the I/O 14 based on the program, causes the data to be temporarily stored in the RAM 15, reads the data from the RAM 15 as needed, performs weight operation processing, and then outputs the weight operation result from the I/O 14.

The weight calculation device with the above-described configuration uses a weight calculation method to suppress deterioration of SINR for a target Doppler frequency, so that a good SINR characteristic can be obtained. The adaptive array antenna of the receiver unit of the radar device according to the embodiment employs this weight calculation device and performs a weight calculation on an output signal of each antenna element. Accordingly, the adaptive array antenna according to the embodiment can form a synthetic beam having a good SINR characteristic.

The adaptive array antenna is employed in the radar device, such as a synthetic aperture radar device for acquiring targets. Accordingly, in the radar device using the adaptive array antenna according to the embodiment, the adaptive array antenna can form a synthetic beam having a good SINR characteristic. Thus, a target can be well acquired.

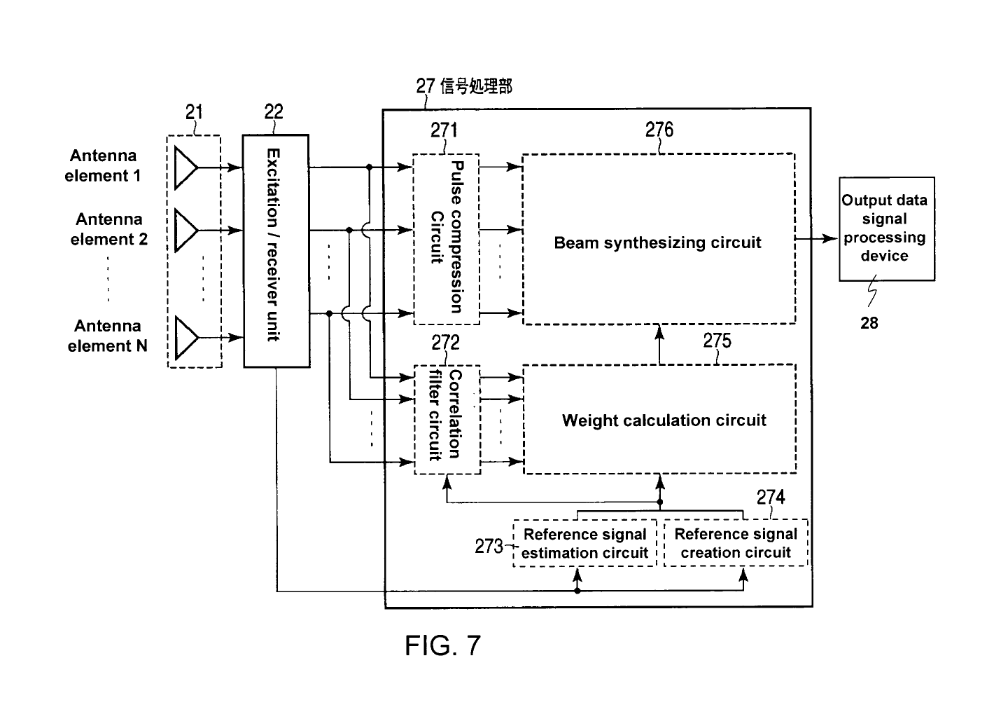

FIG. 7 shows a schematic block diagram of the radar device in which the weight calculation device according to the embodiment is mounted. In FIG. 7, reference numeral 21 is an array antenna having N antenna elements. The array antenna 21 radiates a radar pulse which is outputted from an excitation/receiver unit 22 at radio wavelengths and receives a radar pulse (that is, a reflected signal) which is reflected by the target. The array antenna 21 configures an adaptive array antenna together with the excitation/receiver unit 22 and the signal processing unit 27. A received signal outputted from each antenna element of the antenna 21 is detected by the excitation/receiver unit 22 and the output data of the excitation/receiver unit 22 are sent to the signal processing unit 27.

The signal processing unit 27 has a pulse compression circuit 271, a correlation filter circuit 272, a reference signal estimation circuit 273, a reference signal creation circuit 274, a weight calculation circuit 275, and a beam synthesizing circuit 276. The pulse compression circuit 271 compresses the output data of the excitation/receiver unit 22. The pulse compression unit 3 includes a storage region corresponding to the multiple processing range cells. The number of the processing range cells corresponds to the number of the antenna elements. Each processing range cell has multiple range cells, each range cell being equivalent to a pulse width, and the number of the range cells is equivalent to a predetermined distance. The data which are outputted by the excitation/receiver unit 22 are compressed and the compressed data are sequentially stored in the range cell in a position corresponding to a receiving timing. Also, the compressed data are sequentially sent to the beam synthetic circuit 276 from the pulse compression circuit 271.

The output signals of some of the antenna elements are sent to the reference signal estimation circuit 273 via the excitation/receiver unit 22 and are used as a reference for the amplitude and phase of the received signal. The excitation/receiver unit 22 regularly outputs the data of the output signal of the antenna element to the reference signal estimation circuit 273, and the reference signal estimation circuit 273 estimates a reference signal corresponding to the target signal from the output signal of the antenna element for calculating a weight for a range cell equivalent to a predetermined distance and creates an estimated reference signal. In other words, the reference signal estimation circuit 273 estimates a reference signal equivalent to a sample value of a radar transmission waveform from the received signal. Also, the excitation/receiver unit 22 regularly sends data equivalent to the sample value of the radar transmission waveform to the reference signal creation circuit 274 and the reference signal creation circuit 274 creates a reference signal.

The correlation filter circuit 272 creates data in which a component correlating with a target signal is removed from the received signal by applying a correlation filter to data (received signal) which are outputted from the excitation/receiver unit 22. Note that the target signal means a signal based on a radar pulse which is reflected from the target. The correlation filter circuit 272 uses the above-described correlation filter. Also, the weight calculation circuit 275 calculates an adaptive weight based on the data created by the correlation filter circuit 272. The beam synthesizing circuit 276 creates output data by performing weight control on the data output from the pulse compression circuit 271 based on the adaptive weight. As described above, the signal processing apparatus 27 can obtain output data from which an undesired signal component is removed by performing the weight control on the output signal of the array antenna 21. After that, the output data from the signal processing apparatus 27 are sent to the output data signal processing device 28, and then the output data signal processing device 28 detects the target. For example, the output data signal processing device 28 detects a shape of the target.

In the weight control in the adaptive signal processing method with the above-described configuration, a weight operation for each range cell is performed in the weight calculation circuit 275 for calculating an adaptive weight. The foregoing weight calculation method is used for this weight calculation circuit 275. In other words, a weight is calculated based on the output data which are obtained by applying the correlation filter to the received signal. The correlation filter may be (1) a correlation filter in which a filter coefficient is calculated in advance using a reference signal and then the calculated filter coefficient is applied to a received signal, (2) a correlation filter in which multiple filter coefficients are calculated in advance using multiple reference signals and then the calculated filter coefficients are applied to a received signal, (3) a correlation filter in which a filter coefficient is dynamically calculated by estimating a reference signal from a received signal and then the calculated filter coefficient is applied to a received signal, or (4) a correlation filter including these correlation filters in multiple stages. With this, the correlation filter outputs data in which a component correlating with a target signal is removed from the received signal.

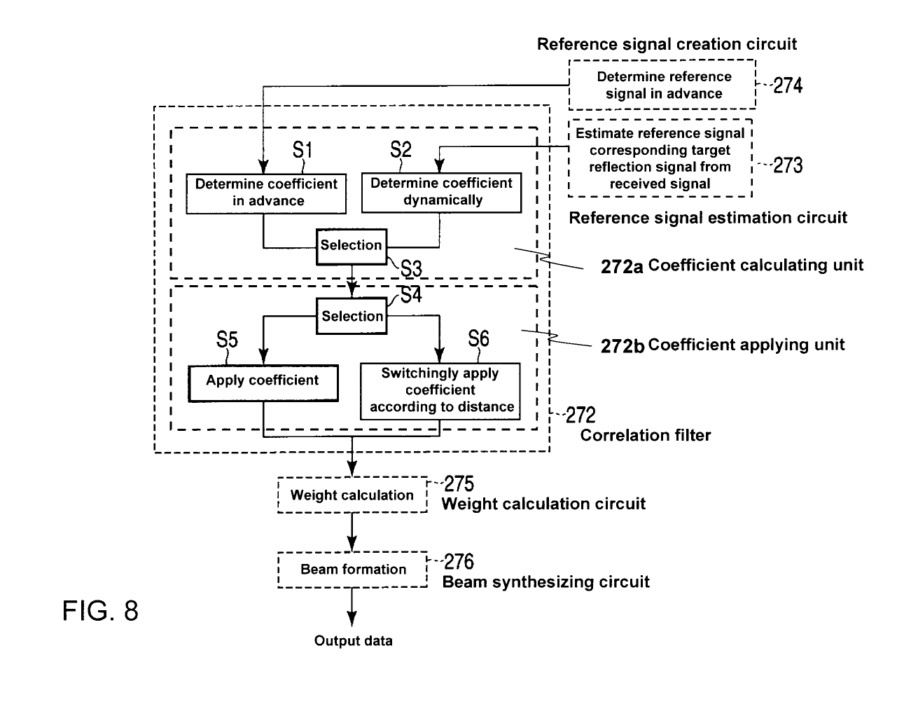

FIG. 8 shows a processing flow of the correlation filter circuit 272 according to the embodiment. The correlation filter circuit 272 has a coefficient calculation unit 272a and a coefficient applying unit 272b. The coefficient calculation unit 272a includes a step S1 of determining a filter coefficient in advance if the reference signal creation circuit 274 determines a reference signal in advance and a step S2 of dynamically determining a filter coefficient if the reference signal estimation circuit 273 estimates a reference signal corresponding to a target signal from the received signal. Also, the coefficient calculation unit 272a includes a step S3 of arbitrarily selecting any one of the step S1 and the step S2. Also, the coefficient applying unit 272b includes a step S5 of applying the filter coefficient obtained at step S1 or S2, a step S6 of switchingly applying the filter coefficient obtained at the step S1 or S2 according to a distance, and a step S4 of selecting step S5 or S6. At the step S4, the step S5 is selected at the initial processing and the step S6 is selected during stationary operation.

The correlation filter circuit 272 sends a processing result to the weight calculation circuit 275. The weight calculation circuit 275 selects a weight calculation algorithm based on the reference signal which is determined in advance or on the estimated reference signal. Also, the weight calculation circuit 275 calculates an adaptive weight based on the output data of the processing result of the correlation filter circuit 272, the number of pulses determined according to an operation time and a signal processing gain, and the coefficient determined according to the distance.

Note that the weight calculation circuit 275 includes processing of integrating the adaptive weights calculated for all the received signals and processing of multiplying the adaptive weights calculated for all the received signals by the complex weight and of integrating the resultant adaptive weights, and selects any one of these processing. The result that the weight calculation circuit 275 calculates is sent to the beam synthesizing circuit 276. The beam synthesizing circuit 276 performs weight processing on the output data of the pulse compression circuit 271 and outputs the output data in which a beam is synthesized.

Subsequently, the output data processing unit 28 of the radar device determines if a target detection result is obtained from the output data in which a beam is synthesized. If the target detection result is not obtained, the output data processing unit 28 instructs the weight calculation circuit 275 to increase the number of pulses used for the weight calculation up to the upper limit of the operation time. With this, a receive pulse to be used for weight calculation can be automatically selected from the target detection result.

In the present embodiment, the correlation filter is not limited to the correlation filter shown in FIG. 8. The correlation filter may be (1) a correlation filter in which a filter coefficient is calculated using a reference signal and the calculated filter coefficient is applied to a received signal, (2) a correlation filter in which multiple filter coefficients are calculated using multiple reference signals and the calculated filter coefficients are applied to a received signal, (3) a correlation filter in which a filter coefficient is dynamically calculated by estimating a reference signal from a received signal and the calculated filter coefficient is applied to a received signal, or (4) a correlation filter which includes these correlation filters in multiple stages and is applied to a received signal. Any of these correlation filters can remove a component correlating with the target signal from the received signal. Accordingly, the data in which the component correlating with the target signal is removed from the received signal are used to perform the weight calculation and the weight processing on the received signal, so that the receiver unit of the radar device can output the output data in which an undesired component other than the target signal is removed from the received signal.

These correlation filter circuits can surely remove the component correlating with the target signal from the received signal. For this reason, with a view to avoiding the suppression of the target signal in the weight processing, there is no need to divide the received signal into multiple ranges and to calculate, from the data from which the data of a weight application range are removed, a weight for each weight application range. Accordingly, the weight calculation method according to the embodiment can obtain a weight with at least one calculation and can obtain a faster operation time and a good SINR characteristic for the target Doppler frequency.

Also, the weight calculation device according to the embodiment uses a signal of the processing result obtained by applying the above-described correlation filter to the received signal as a signal to be used for the weight calculation. For this reason, the component correlating with the target signal is removed from the received signal with regard to the signal to be used for the weight calculation. Thus, with a view to avoiding the suppression of the target signal, there is no need to divide the received signal into multiple ranges and to calculate, from the data from which the data of a weight application range are removed, a weight for each weight application range. In addition, the weight calculation device according to the embodiment can obtain a weight with at least one calculation and can provide a faster operation time and a good SINR characteristic for the target Doppler frequency.

Also, the adaptive array antenna according to the embodiment employs a weight calculation circuit capable of shortening the time required for the weight calculation, so that a good received synthetic beam can be formed in a short time.

Furthermore, the radar device according to the embodiment mounts the adaptive array antenna capable of forming the received synthetic beam in a short time, so that a target can be quickly acquired.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A correlation filter used in a radar device including an adaptive array antenna configured to form a received synthetic beam from a received signal outputted by an antenna array having a plurality of antenna elements arranged in an array, in such a way that an adaptive weight for a phase and amplitude of the received signal is applied to the received signal to nullify a gain in a direction other than an arrival direction of a target signal which is a reflected signal of a radar pulse reflected from a target and is contained in the received signal, the correlation filter comprising;
coefficient calculating means for calculating a filter coefficient in advance by using a reference signal being a sample value of a transmission waveform of a radar pulse transmitted by the radar device, the filter coefficient being for suppressing a component correlating with the target signal in the received signal; and
coefficient applying means for removing the component correlating with the target signal from the received signal by applying the filter coefficient calculated by the coefficient calculating means to the received signal, wherein
the correlation filter is used as preprocessing before calculation of the adaptive weight.

2. A correlation filter used in a radar device including an adaptive array antenna configured to form a received synthetic beam from a received signal outputted by an antenna array having a plurality of antenna elements arranged in an array, in such a way that an adaptive weight for a phase and amplitude of the received signal is applied to the received signal to nullify a gain in a direction other than an arrival direction of a target signal which is a reflected signal of a radar pulse reflected from a target and is contained in the received signal, the correlation filter comprising:
coefficient calculating means for calculating a plurality of filter coefficients in advance by using a plurality of reference signals, each being a sample value of a transmission waveform of a radar pulse transmitted by the radar device, the filter coefficients being for suppressing a component correlating with the target signal from the received signal; and
coefficient applying means for removing the component correlating with the target signal from the received signal in such as way that one of the plurality of filter coefficients calculated by the coefficient calculating means is applied to the received signal with the plurality of filter coefficients changed over from one to another according to a distance of the received signal, wherein
the correlation filter is used as preprocessing before calculation of the adaptive weight.

3. A correlation filter used in a radar device including an adaptive array antenna configured to form a received synthetic beam from a received signal outputted by an antenna array having a plurality of antenna elements arranged in an array, in such a way that an adaptive weight for a phase and amplitude of the received signal is applied to the received signal to nullify a gain in a direction other than an arrival direction of a target signal which is a reflected signal of a radar pulse reflected from a target and is contained in the received signal, the correlation filter comprising:
coefficient calculating means for dynamically calculating a filter coefficient by using a reference signal which is a sample value of a transmission waveform of a radar pulse transmitted by the radar device and estimated from the received signal, the filter coefficient being for suppressing a component correlating with the target signal in the received signal; and
coefficient applying means for removing the component correlating with the target signal from the received signal by applying the filter efficient calculated by the coefficient calculating means to the received signal, wherein
the correlation filter is used as preprocessing before calculation of the adaptive weight.

4. A correlation filter comprising a plurality of combinations of the coefficient calculating means and the coefficient applying means according to any of claims 1 to 3,
wherein the combinations of the coefficient calculating means and the coefficient applying means are connected together in a plurality of stages.

5. A weight calculation method used in a radar device including an adaptive array antenna configured to form a received synthetic beam from a received signal outputted by an antenna array having a plurality of antenna elements arranged in an array, in such a way that an adaptive weight is applied to the received signal to nullify a gain in a direction other than an arrival direction of a target signal which is a reflected signal of a radar pulse reflected from a target and is contained in the received signal, the method comprising:
calculating the adaptive weight from a signal obtained by applying the correlation filter according any of claims 1 to 4 to the received signal.

6. A weight calculation device used in a radar device including an adaptive array antenna configured to form a received synthetic beam from a received signal outputted by an antenna array having a plurality of antenna elements arranged in an array, in such a way that an adaptive weight is applied to the received signal to nullify a gain in a direction other than an arrival direction of a target signal which is a reflected signal of a radar pulse reflected from a target and is contained in the received signal, the weight calculation device comprising:
weight calculating means for calculating the adaptive weight from a signal obtained by applying the correlation filter according any of claims 1 to 4 to the received signal.

7. An adaptive array antenna, comprising:
an array antenna including a plurality of arrayed antenna elements and configured to output a received signal containing a target signal being a reflected signal of a radar pulse reflected from a target;
the correlation filter according to any of claims 1 to 4;
a weight calculation unit configured to calculate an adaptive weight from a signal obtained by applying the correlation filter to the received signal; and
a beam forming unit configured to form a received synthetic beam by performing weight control based on the adaptive weight on the received signal to nullify a gain in a direction other than an arrival direction of the target signal.

8. A radar device comprising:
the adaptive array antenna according to claim 7;
an excitation unit configured to create a radar pulse to be launched from the array antenna; and
an output data processor configured to detect a target from output data which are outputted by the adaptive array antenna.

9. The radar device according to claim 8, wherein the output data processor detects a shape of the target.
